(19) United States
(12) Patent Application Publication
(10) Pub. No.: US 2006/0056945 A1
(43) Pub. Date: Mar. 16, 2006

(54) PARTS TRANSFERRING APPARATUS

(75) Inventor: Koji DAIO, Joyo, Kyoto, (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: C/O SEIWA ELECTRIC MFG. CO., LTD., Joyo-ku, Kyoto-shi, (JP)

(21) Appl. No.: 11/161,495

(22) Filed: Aug. 5, 2005

(30) Foreign Application Priority Data
Sep. 10, 2004 (JP) 2004-263547

(51) Int. Cl. B65G 65/04

(52) U.S. Cl. 414/403

(57) ABSTRACT

An object of the present invention is to minimize a fear of damaging parts when they are transferred from a carry-in cassette to a carry-out cassette and to shorten a transferring time. Tip end portions of a thrusting-down pin 30 and a suction collet 50 are brought into contact with a back face of an adhesive sheet 11 of a carry-in cassette 10 to thrust down a semiconductor chip 1 and the thrust-down semiconductor chip 1 is received on a carry-out cassette 20A, 20B, or 20C and stuck on an adhesive sheet 21A, 21B, or 21C of a receiving face 201A, 201B, or 201C of the carry out cassette 20A, 20B, or 20C.

### BACKGROUND OF THE INVENTION

1. Field of the Invention

The present invention relates to a parts transferring apparatus for stripping off a plurality of parts stuck on an adhesive sheet of a carry-in cassette and transferring the parts onto a carry-out cassette.

2. Description of the Related Art

Representative examples of parts transferred in this manner are electronic parts such as a light-emitting diode, a resistor, and a capacitor. These parts are normally stuck on an adhesive sheet after production and are set in a carry-in cassette while they are still on the adhesive sheet. Then, a rank of the parts on the carry-in cassette are determined by an inspection device and the parts on the adhesive sheet are stripped off by the parts transferring apparatus and successively transferred to the carry-out cassettes corresponding to the ranks.

There are prior-art parts transferring apparatus of a suction type (see Japanese Patent Application Laid-open No. 2000-43832 and the like, for example) in which parts are held by a suction collet by suction and of a wheel type (see Japanese Patent Application Laid-open No. 08-37395 and the like, for example) in which parts are stripped off by a stripping-off wheel and a thrusting-down collet.

However, according to the above pieces of prior art, there is a fear that the parts may be damaged in suction by the suction collet in the suction type and in stripping off by the stripping-off wheel in the wheel type. The suction type is more commonly used as the parts transferring apparatus than the wheel type when the parts stripped off from the adhesive sheet need to be transferred to the predetermined carry-out cassette. However, it is necessary to move the suction collet from the carry-in cassette to the carry-out cassette, though a distance of this movement is long. In this regard, it is difficult to shorten a transferring time of the part.

### SUMMARY OF THE INVENTION

The present invention has been made against the above-described background and it is an object of the invention to provide a parts transferring apparatus with which there is almost no fear that the parts are damaged when they are transferred from the carry-in cassette to the carry-out cassette and the transferring time can be shortened.

A parts transferring apparatus according to the present invention is an apparatus for stripping off a plurality of parts attached on an adhesive sheet of a carry-in cassette and transferring the parts onto a carry-out cassette, the apparatus comprising: a carry-in cassette allowing attachment of an adhesive sheet onto a lower face thereof for attaching the plurality of parts, a thrusting-down pin having a tip end portion contactable with a back face of the adhesive sheet through an opening in the carry-in cassette, a pin moving mechanism coupled to a base end portion of the thrusting-down pin for relatively moving the thrusting-down pin in a vertical direction, between a stripping-off position where the tip end portion of the thrusting-down pin is in contact with the back face of the adhesive sheet to strip off the parts and a retracting position where the tip end portion is not in contact with the carry-in cassette; a carry-out cassette having a receiving face for receiving the parts thrust down by convex deformation of the adhesive sheet of the carry-in cassette as a result of contact of the tip end portion of the thrusting-down pin with the adhesive sheet, the receiving face being attached with an adhesive sheet for receiving the parts, a cassette moving mechanism for moving the carry-in cassette and the carry-out cassette, and a control unit for controlling the pin moving mechanism and the cassette moving mechanism according to a sequence pattern required to successively transfer the plurality of parts on the carry-in cassette onto the carry-out cassette.

Preferably, the apparatus further includes a suction collet including a hollow cylinder slightly smaller than the parts and allowing insertion of the thrusting-down pin therethrough, and a collet moving mechanism coupled to a base end portion of the suction collet for relatively moving the suction collet in a vertical direction, between a suction position where a tip end portion of the suction collet is in contact with the back face of the adhesive sheet and a retracting position where the tip end portion is not in contact with the carry-in cassette. The control unit used in this case has a function of operating the collet moving mechanism to move the tip end portion of the suction collet to the suction position and then operating the pin moving mechanism to move the tip end portion of the thrusting-down pin to the stripping-off position in transferring the parts on the carry-in cassette onto the carry-out cassette.

Preferably, the thrusting-down pin with the tapered tip end portion is used. The control unit may have functions of receiving measurement data from a measuring device for measuring a rank or a kind of each of the parts on the carry-in cassette, and when successively transferring the plurality of the parts on the carry-in cassette onto the carry-out cassette, recognizing the rank or the kind of each of the parts included in the measurement data and setting the carry-out cassette corresponding to the rank or the kind as a destination to which each of the parts is to be transferred.

With the parts transferring apparatus according to claim 1 of the invention, the tip end portion of the thrusting-down pin is brought into contact with the back face of the adhesive sheet of the carry-in cassette to thrust down the part, the thrust-down part is received by the carry-out cassette and stuck on the adhesive sheet on the receiving face of the carry-out cassette, and the part is transferred from the carry-in cassette to the carry-out cassette through this series of steps. In other words, in transferring from the carry-in cassette to the carry-out cassette, the part does not come in direct contact with the tip end portion of the thrusting-down pin and the receiving face of the carry-out cassette but comes in indirect contact with them through the adhesive sheets. Therefore, there is almost no fear of damaging the part. Furthermore, because the part is transferred with the carry-out cassette positioned directly below the carry-in cassette, the stroke is short and, as a result, the transferring time can be shortened. In these respects, performance as the apparatus can be enhanced.

With the parts transferring apparatus according to claim 2 of the invention, the part is held by the suction collet by suction through the adhesive sheet and, as a result, every part is thrust down in a stable attitude by the thrusting-down pin. Therefore, the thrust-down part can stably be stuck on the adhesive sheet of the carry-out cassette and performance as the apparatus can be enhanced in this respect.

With the parts transferring apparatus according to claim 3 of the invention, when the part is thrust down by the thrusting-down pin through the adhesive sheet, adhesiveness of the adhesive sheet of the carry-in cassette is weakened. Therefore, the thrust-down part can reliably be stuck on the adhesive sheet of the carry-out cassette and performance as the apparatus can be enhanced in this respect.

With the parts transferring apparatus according to claim 4 of the invention, in successively transferring the plurality of parts on the carry-in cassette to the carry-out cassettes corresponding to the ranks or the kinds of the parts, even if there are many kinds of carry-out cassettes, the transferring time does not become much longer and performance as the apparatus can be enhanced in this respect.

### BRIEF DESCRIPTION OF THE DRAWINGS

FIG. 1 is a schematic block diagram of a parts transferring apparatus according to an embodiment of the present invention.

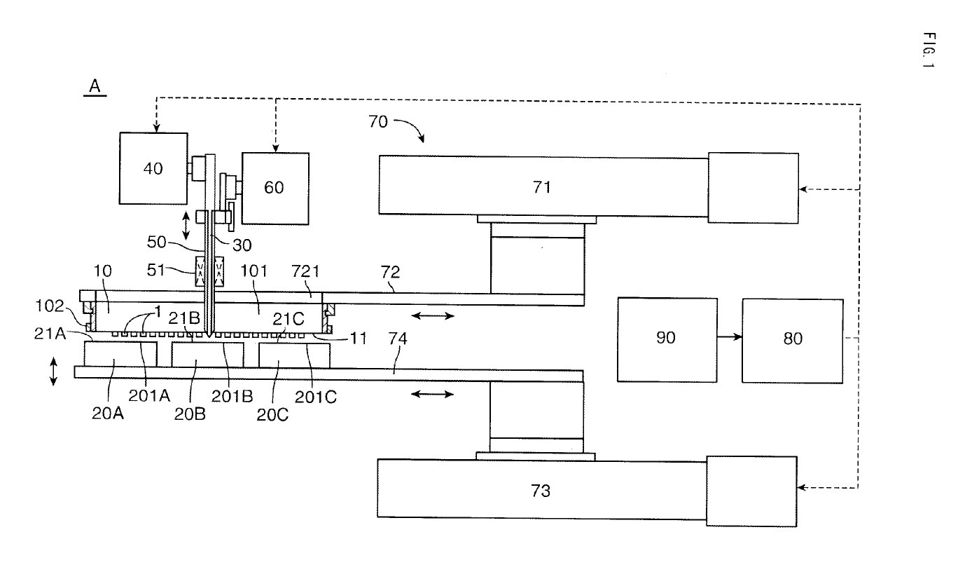

FIG. 2 is Diagrams for explaining examples of a thrusting-down pin of the apparatus, wherein FIG. 2(a) is a side view and FIG. 2(b) is a front view.

### DETAILED DESCRIPTION OF THE PREFERRED EMBODIMENTS

Modes for carrying out the present invention will be described below by reference to the drawings. A parts transferring apparatus A taken herein as an example is disposed on a manufacture line of a light-emitting diode 1 (part) and is an apparatus for stripping off a plurality of light-emitting diodes 1 stuck on an adhesive sheet 11 of a carry-in cassette 10 and successively transferring them to predetermined carry-out cassettes 20A, 20B, and 20C according to their ranks of electric/optical characteristics.

The rank of the electric/optical characteristics of the light-emitting diode 1 is determined by a measuring device 90 disposed at a previous stage of the transferring apparatus A on the manufacture line. Measurement data output from the measuring device 90 is formed of position data indicating a position of the light-emitting diode 1 on the carry-in cassette 10 or on a surface of the adhesive sheet 11 and rank data indicating the rank (three ranks including A, B, and C) of the electric/optical characteristic of the light-emitting diode 1. The measurement data of all the light-emitting diodes 1 stuck on the adhesive sheet 11 is output as a unit to a control unit 80 which will be described later.

The parts transferring apparatus A includes: a carry-in cassette 10 to a lower face of which an adhesive sheet 11 can be stuck, the plurality of light-emitting diodes 1 being stuck on the adhesive sheet 11; a thrusting-down pin 30 having a tip end portion which can come in contact with a back face of the adhesive sheet 11 through an opening 101 of the carry-in cassette 10; a pin moving mechanism 40 coupled to a base end portion of the thrust-down pin 30; a suction collet 50 through which the thrusting-down pin 30 is inserted; a collet moving mechanism 60 coupled to a base end portion of the suction collet 50; carry-out cassettes 20A, 20B, and 20C for receiving the light-emitting diode 1 thrust down when the tip end portion of the thrusting-down pin 30 comes in contact with and deforms the adhesive sheet 11 of the carry-in cassette 10 into a projecting shape, the cassettes 20A, 20B, and 20C mounted with adhesive sheets 21A, 21B, and 21C for sticking the light-emitting diodes 1 to receiving faces 201A, 201B, and 201C; a cassette moving mechanism 70 for separately moving the carry-in cassette 10 and the carry-out cassettes 20A, 20B, and 20C; and the control unit 80 for controlling the pin moving mechanism 40, the collet moving mechanism 60, and the cassette moving mechanism 70 according to a sequence pattern required to successively transfer the plurality of light-emitting diodes 1 on the carry-in cassette 10 to the carry-out cassettes 20A, 20B, and 20C. The respective portions will be described below in detail.

The carry-in cassette 10 is a cassette of circular frame body used for carrying the light-emitting diodes 1 after measurement by the measuring device 90 on the manufacture line and has the opening 101 in itself. The adhesive sheet 11 made of synthetic resin such as polypropylene is attached to a back face of the carry-in cassette 10 by using an outer frame 102. The plurality of light-emitting diodes 1 are stuck on an adhesive face of the adhesive sheet 11 in an arrangement at the time of dancing of a wafer. Such a carry-in cassette 10 can be engaged with a tip end portion of an upper arm 72 of the cassette moving mechanism 70 (described later in detail).

The carry-out cassettes 20A, 20B, and 20C are rectangular cassettes used for respectively carrying the light-emitting diodes 1 of the ranks A, B, and C on the manufacture line and have upper faces as the receiving faces 201A, 201B, and 201C. To the receiving faces 201A, 201B, and 201C, the adhesive sheets 21A, 21B, and 21C made of synthetic resin such as polypropylene are attached. To the adhesive faces of the adhesive sheets 21A, 21B, and 21C, the light-emitting diodes 1 transferred from the carry-in cassette 10 can be stuck. Such carry-out cassettes 20A, 20B, and 20C can be engaged with a tip end portion of a lower arm 74 of the cassette moving mechanism 70 at constant intervals (described later in detail).

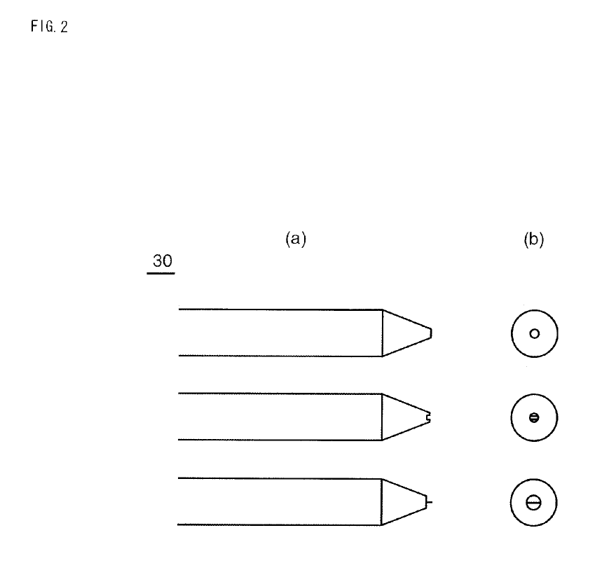

The thrusting-down pin 30 is a stick-shaped body having an outside diameter slightly smaller than an inside diameter of the suction collet 50 and has a tapered tip end portion. For example, there are pins of a type having a flat tip end face, a type having a tip end face with a recessed portion, and a type having a tip end face with a projecting portion as shown in FIG. 2 and it is preferable to cheese proper one which can easily strip the light-emitting diode 1 from the adhesive sheet 11 of the carry-in cassette 10 and can reliably stick the light-emitting diode 1 to the adhesive sheet 21A of the carry-out cassette 20A or the like. The thrusting-down pin 30 is inserted into the suction collet 50 and is supported for vertical movement.

The pin moving mechanism 40 is a motor feed mechanism disposed in midair and moves the thrusting-down pin 30 in a vertical direction. In other words, the mechanism 40 moves the thrusting-down pin 30 between a stripping-off position where the tip end portion of the thrusting-down pin 30 comes in contact with the back face of the adhesive sheet 11 to strip off the light-emitting diode 1 and a retracting position where the tip end portion is not in contact with the carry-in cassette 10 and the upper arm 72.

The suction collet 50 is a hollow cylinder having an outside diameter slightly smaller than the light-emitting diode 1. A vacuum pump (not shown) is connected to the collet 50. The thrusting-down pin 30 is inserted through the collet 50. The suction collet 50 is supported for vertical movement on a slide bearing 51 supported in midair.

The collet moving mechanism 60 is a motor feed mechanism disposed in midair in the vicinity of the pin moving mechanism 40 and moves the suction collet 50 in the vertical direction. In other words, the mechanism 60 moves the suction collet 50 in the vertical direction between a suction position where the tip end portion of the suction collet 50 is in contact with the back face of the adhesive sheet 11 and a retracting position where the tip end portion is not in contact with the carry-in cassette 10 and the upper arm 72.

The cassette moving mechanism 70 has an upper XY table 71 for moving the plate-shaped upper arm 72 in a horizontal direction and a lower XYZ table 73 for moving the plate-shaped lower arm 74 in the horizontal and vertical directions. A hole 721 is formed in the tip end portion of the upper arm 72 and the carry-in cassette 10 can be engaged with a lower face of the tip end portion. When the carry-in cassette 10 is mounted in a downward orientation to the tip end portion of the upper arm 72, the opening 101 of the carry-in cassette 10 and the hole 721 communicate with each other. On the other hand, with an upper face of the tip end portion of the lower arm 74, the carry-out cassettes 20A, 20B, and 20C can be engaged at predetermined intervals.

The upper XY table 71 is disposed in midair in the vicinity of the collet moving mechanism 60 and moves the upper arm 72 with a large stroke in the horizontal direction to thereby move the carry-in cassette 10 between a handing position where the cassette 10 can be handed by a carry-in cassette attaching/detaching device (not shown) and a position directly below the thrusting-down pin 30 and the like. On the other hand, the table 71 can move the upper arm 72 with a small stroke in a horizontal direction to thereby position every light-emitting diode 1 arranged on the carry-in cassette 10 directly under the thrusting-down pin 30 and the like.

The lower XYZ table 73 is disposed in midair at a position directly below the upper XY table 71 and moves the lower arm 74 with a large stroke in the horizontal direction to thereby move the carry-out cassette 20A, 20B, or 20C between a handing position where the cassette 20A, 20B, or 20C can be handed by a carry-out cassette attaching/detaching device (not shown) and a position directly below the thrusting-down pin 30 and the like. On the other hand, the table 73 can move the lower arm 74 with a small stroke in the horizontal direction and the vertical direction to thereby bring the carry-out cassette 20A, 20B, or 20C to a position close to the carry-in cassette 10 and to position each part address position of the carry-out cassette 20A, 20B, or 20C directly under the thrusting-down pin 30 and the like.

As the control unit 80, a PC for control is used here. In other words, in addition to various signals output from the carry-in cassette attaching/detaching device and the carry-out cassette attaching/detaching device, measurement data output from the measuring device 90 is input to thereby sequentially control the pin moving mechanism 40, the collet moving mechanism 60, the upper XY table 71, and the lower XYZ table 73 according to sequence patterns stored in advance in internal memory. Especially, in successively transferring the plurality of light-emitting diodes 1 on the carry-in cassette 10 to the carry-out cassettes 20, the PC includes a function of recognizing the rank data included in the measurement data to set the carry-out cassette 20A, 20B, or 20C corresponding to the rank as a destination to which the light-emitting diode 1 is to be transferred.

A sequence operation implemented by the control unit 80 is as follows.

First, the measurement data related to the light-emitting diode 1 on the carry-in cassette 10 is input from the measuring device 90 and is stored in the internal memory. Then, when a signal announcing that the carry-in cassette 10 is set at the tip end portion of upper arm 72 from the carry-in cassette attaching/detaching device is input, the upper XY table 71 is operated at a predetermined timing to move the carry-in cassette 10 from the handing position to the position directly below the thrusting-down pin 30 and the like.

Then, the measurement data in the internal memory is read out, the upper XY table 71 is operated based on position data included in the measurement data and the light-emitting diode 1 is brought to the position directly below the thrusting-down pin 30 and the like. On the other hand, the lower XYZ table 73 is operated based on rank data included in the measurement data and the carry-out cassette 20A, 20B, or 20C corresponding to the rank of the light-emitting diode 1 is brought to the position directly below the thrusting-down pin 30 and the like. In other words, the rank data included in the read-out measurement data is recognized and the carry-out cassette 20A is set as a destination to which the light-emitting diode 1 is to be transferred when the rank of the light-emitting diode 1 is A. The lower arm 74 is moved so that the carry-out cassette 20A is brought to the position directly below the thrusting-down pin 30 and the like. When the rank of the light-emitting diode 1 is B or C, the lower arm 74 is moved similarly so that the carry-out cassette 20B or 20C is brought to the position directly below the thrusting-down pin 30 and the like.

After such positioning, the pin moving mechanism 40 and the collet moving mechanism 60 are operated to move down the thrusting-down pin 30 and the suction collet 50 by a long distance to respectively move the pin 30 and the collet 50 from the retracting position to a position slightly above and close to the back face of the adhesive sheet 11 of the carry-in cassette 10. Then, the vacuum pump is operated and the collet moving mechanism 60 is operated. In this way, the suction collet 50 is moved from the close position to the suction position to bring the tip end portion of the collet 50 in contact with a position on the back face of the adhesive sheet 11 of the carry-in cassette 10 where the semiconductor chip 1 is stuck.

Then, slightly after the collet moving mechanism 60 is operated, the pin moving mechanism 40 is operated. In this way, the thrusting-down pin 30 is moved from the close position to the stripping-off position to bring the tip end portion of the pin 30 into contact with the back face of the adhesive sheet 11 of the carry-in cassette 10 to thereby partially deform the adhesive sheet 11 into the projecting shape. As a result, the light-emitting diode 1 is thrust down. If the rank of the thrust-down light-emitting diode 1 is A, the diode 1 is received on the receiving face 201A of the carry-out cassette 20A and stuck to the adhesive sheet 21A. The light-emitting diodes 1 of the ranks B and C are similarly received on the receiving faces 201B and 201C of the carry-out cassettes 20B and 20C and stuck to the adhesive sheets 21B and 21C.

After the thrusting-down pin 30 is moved to the stripping-off position, the pin moving mechanism 40 and the collet moving mechanism 60 are operated reversely to respectively move the thrusting-down pin 30 from the stripping-off position to the close position and the suction collet 50 from the suction position to the close position.

After the above processing is completed, the next measurement data in the internal memory is read out and the similar processing is performed. If this is repeated, all the light-emitting diodes 1 on the carry-in cassette 10 are successively transferred to the carry-out cassette 20A, 20B, or 20C in this process.

If all the processings are completed, the pin moving mechanism 40 and the collet moving mechanism 60 are operated to return the thrusting-down pin 30 and the suction collet 50 to a standby position. Then, the upper XY table 71 is operated reversely to move the carry-in cassette 10 to the handing position.

During the above processing, when the number of light-emitting diodes 1 transferred to the carry-out cassettes 20A, 20B, and 20C has reached a predetermined number or more, an interrupt processing is performed. In other words, the lower XYZ table 73 is operated to move the carry-out cassettes 20A, 20B, and 20C to the handing position by the carry-out cassette attaching/detaching device. Then, if a signal announcing that a new carry-out cassette 20A, 20B, or 20C is set at the tip end portion of the lower arm 74 by the device is input, the lower XYZ table 73 is operated reversely to move the carry-out cassettes 20A, 20B, and 20C from the handling position by the carry-out cassette attaching/detaching device to the position directly below the thrusting-down pin 30 and the like. Thus, the interrupt processing is completed.

According to the parts transferring apparatus A having the above structure, the tip end portion of the thrusting-down pin 30 and the tip end portion of the suction collet 50 do not directly come in contact with the light-emitting diodes 1 on the receiving faces 201A, 201B, and 201C of the carry-out cassettes 20A, 20B, and 20C and indirectly come in contact with the diodes 1 through the adhesive sheet 11 of the carry-in cassette 10 and the adhesive sheets 21A, 21B, and 21C of the carry-out cassettes 20A, 20B, and 20C. Therefore, when the light-emitting diodes 1 are transferred from the carry-in cassette 10 to the carry-out cassettes 20A, 20B, and 20C, there is no fear that the light-emitting diodes 1 are damaged.

Moreover, because the tip end portion of the thrusting-down pin 30 is tapered, when the light-emitting diode 1 is thrust down, a substantial sticking area of the adhesive sheet 11 to the light-emitting diode 1 is reduced according to a degree of thrusting down of the diode 1 and, as a result, adhesiveness is gradually weakened. Therefore, without especially devising a method of providing greater adhesiveness to the adhesive sheet 21 of the carry-out cassette 20 than to the adhesive sheet 11 of the carry-in cassette 10, it is possible to reliably stick the light-emitting diode 1 on the adhesive sheet 21 of the carry-in cassette 10 to the adhesive sheet 21A, 21B, or 21C on the carry-out cassette 20 for being transferred.

Moreover, the light-emitting diode 1 is held by suction by the suction collet 50 through the adhesive sheet 11 and therefore every diode 1 can be constantly thrust down by the thrusting-down pin 30 in a stable attitude. As a result, even if the light-emitting diode 1 is not stuck to the adhesive sheet 21 of the carry-in cassette 10 in a normal attitude, the light-emitting diode 1 can stably be stuck on the adhesive sheet 21A, 21B, or 21C of the receiving face 201A, 201B, or 201C of the carry-out cassette 20A, 20B, or 20C.

Furthermore, because the light-emitting diode 1 is transferred to the carry-out cassette 20A, 20B, or 20C directly below the carry-in cassette 10, the stroke is shorter than that in the prior-art suction type and therefore the transferring time can be shortened. In these respects, performance as the apparatus can be enhanced.

Of course objects of the parts transferring apparatus according to the invention are not limited to the light-emitting diodes and the apparatus is applicable to any parts. Also, the numbers of carry-in cassettes and carry-out cassettes may be changed, the suction collet may be omitted, and a thrusting-down pin which is not tapered may be employed, for example. Methods of moving the thrusting-down pin, the carry-in cassette, and the like are not limited to the above methods.

1. A parts transferring apparatus for stripping off a plurality of parts attached on an adhesive sheet of a carry-in cassette and transferring the parts onto a carry-out cassette, the apparatus comprising:
a carry-in cassette allowing attachment of an adhesive sheet onto a lower face thereof for attaching the plurality of parts;
a thrusting-down pin having a tip end portion contactable with a back face of the adhesive sheet through an opening in the carry-in cassette;
a pin moving mechanism coupled to a base end portion of the thrusting-down pin for relatively moving the thrusting-down pin in a vertical direction, between a stripping-off position where the tip end portion of the thrusting-down pin is in contact with the back face of the adhesive sheet to strip off the parts and a retracting position where the tip end portion is not in contact with the carry-in cassette;
a carry-out cassette having a receiving face for receiving the parts thrust down by convex deformation of the adhesive sheet of the carry-in cassette as a result of contact of the tip end portion of the thrusting-down pin with the adhesive sheet, the receiving face being attached with an adhesive sheet for receiving the parts;
a cassette moving mechanism for moving the carry-in cassette and the carry-out cassette; and
a control unit for controlling the pin moving mechanism and the cassette moving mechanism according to a sequence pattern required to successively transfer the plurality of parts on the carry-in cassette onto the carry-out cassette.

2. A parts transferring apparatus according to claim 1 further comprising:
a suction collet including a hollow cylinder slightly smaller than the parts and allowing insertion of the thrusting-down pin therethrough; and
a collet moving mechanism coupled to a base end portion of the suction collet for relatively moving the suction collet in a vertical direction, between a suction position where a tip end portion of the suction collet is in contact with the back face of the adhesive sheet and a retracting position where the tip end portion is not in contact with the carry-in cassette,
wherein the control unit has a function of operating the collet moving mechanism to move the tip end portion of the suction collet to the suction position and then operating the pin moving mechanism to move the tip end portion of the thrusting-down pin to the stripping-off position in transferring the parts on the carry-in cassette onto the carry-out cassette.

3. A parts transferring apparatus according to claim 1 or 2, wherein the tip end portion of the thrusting-down pin is tapered.

4. A parts transferring apparatus according to claim 1 or 2, further comprising a plurality of carry-out cassettes, wherein the control unit has functions of receiving measurement data from a measuring device for measuring a rank or a kind of each of the parts on the carry-in cassette, and when successively transferring the plurality of the parts on the carry-in cassette onto the carry-out cassette, recognizing the rank or the kind of each of the parts included in the measurement data and setting the carry-out cassette corresponding to the rank or the kind as a destination to which each of the parts is to be transferred.
